(19) United States
(12) Patent Application Publication
(10) Pub. No.: US 2021/0345615 A1
(43) Pub. Date: Nov. 11, 2021

(54) FORTIFIED SANITIZING COMPOSITION HAVING ANTIMICROBIAL CHARACTERISTICS

(71) Applicant: 2 V Industries, Inc., Wixom, MI (US)

(72) Inventors: Vijay Bedi, Wixom, MI (US); Vivek Bedi, Wixom, MI (US); Matthew Roberts, Wixom, MI (US)

(21) Appl. No.: 17/314,572

(22) Filed: May 7, 2021

Related U.S. Application Data
(60) Provisional application No. 63/022,422, filed on May 8, 2020.
(60) Provisional application No. 63/105,312, filed on Oct. 25, 2020.

(51) Int. Cl. A01N 55/00; A01N 33/12; A01N 25/06; A01N 31/02

(52) U.S. Cl. CPC A01N 55/00; A01N 31/02; A01N 25/06; A01N 33/12

(57) ABSTRACT

A composition that includes an effective amount of a quaternary ammonium silane compound; an effective amount of a benzalkonium chloride compound; between 50 volume percent and 90 volume percent of a short chain alcohol have between one and six carbon atoms; and between 10 percent and 50 percent water. The composition is effective at reducing or eliminating one or more pathogens from a contact surface and preventing recolonization for an interval of at least one hour in certain applications. In certain applications and embodiments, the pathogen eliminated can be one of at least viruses, bacteria, fungi and spores including but not limited to SARS-CoV-2.

### BACKGROUND

This application is a non-provisional utility application that claims priority to U.S. Provisional Application Ser. No. 63/022,422, filed May 8, 2020, currently pending, and U.S. Provisional Application Ser. No. 63/105,312, filed Oct. 25, 2020, currently pending, the Specifications of which are incorporated by reference herein.

The present disclosure is directed to a cleaning and sanitizing composition that can be used on various surfaces including, but not limited to, hard and soft surfaces. The disclosure is also directed to compositions that can be employed to impart antimicrobial characteristics to the surfaces onto which the composition is imparted.

Various compositions have been proposed to reduce or eliminate biological pathogens such microbial contaminant such as bacterial, fungi and viruses that are present on the various surfaces and objects. Many of these compositions accomplish antimicrobial actions by wetting the surface with the applied material. The antimicrobial action ceases or declines as the applied composition dries leaving the surface open for inoculation. Various materials have been proposed to enhance the antimicrobial characteristics of various surfaces, however the interval during which the surface antimicrobial characteristics are enhanced is limited. Also, the antimicrobial effectiveness of the given composition can be compromised when the antimicrobial composition is applied to an unclean or dirty surface contaminated with dirt, grime or the like.

It would be desirable to provide a composition that can be applied to a variety of surfaces and materials to reduce or eliminate microbial contamination present. It is also desirable to provide composition that can impart antimicrobial characteristics to the surface or material that will endure for an interval subsequent to application. It would also be desirable to provide a provide an antimicrobial composition that can have cleaning functions in addition to antimicrobial action. It would also be desirable to provide a composition that can reduce or eliminate contamination by microbial pathogens including, but not limited to bacteria, viruses fungi and the like. In certain embodiments, the virus can be a virus from the family Picornaviridae or Coronaviridae.

There is a need for compositions with improved efficacy against microorganisms, A solution to this technical problem is provided by the disclosure and is characterized in the claims.

### SUMMARY

Disclosed is a treatment composition that includes an effective amount of at least one quaternary ammonium silane compound; an effective amount of at least one benzalkonium chloride compound; between 50 volume percent and 90 volume percent of a short chain alcohol having between one and six carbon atoms; and between 10 percent and 50 percent water. The composition is effective at reducing or eliminating one or more microbiological pathogens from a contact surface and can prevent recolonization for an interval of at least one hour in certain applications.

In certain applications and embodiments, the microbiological pathogen eliminated can be one of at least viruses, bacteria, fungi and spores. The treatment composition as disclosed herein can be effective on surfaces contaminated with one or more viruses including, but not limited one or more viruses such as viruses from the family Picornaviridae or Coronaviridae. In certain embodiments, microbiological pathogen can be or include SARS-CoV-2.

### DETAILED DESCRIPTION

Disclosed is a composition which can be applied to a surface to reduce or eliminate contamination by one or more microbiological pathogens. Also disclosed as a composition that, when applied to a surface, can prevent subsequent contamination or recolonization of the treated surface by microbiological pathogens. Also disclosed is a method for treating one or more surfaces that involves the application of the disclosed composition on one or more surfaces.

The composition as disclosed herein is a stable solution that is composed of water and at least one organic liquid. The organic liquid is one that is at least partially miscible in water and has a boiling point less than water. The composition stable solution as disclosed herein also includes at least one quaternary ammonium organosilane compound and at least one benzalkonium compound. Where desired or required, the composition can also include one or more organic additives. Upon application of the composition as disclosed on the desired contact surface, at least one component of the composition evaporates in a manner that accomplishes the deposition of one or more components on the contact surface. In certain embodiments, the evaporation of one or more components of the composition can occur at differing rates. Without, being bound to any theory, it is believed that the deposition and adherence of specific components employed in the composition as disclosed herein can be advantageously affected by the evaporation rate differential in certain embodiments.

The organic liquid material component in the present composition can be composed on one or more compounds that are in a liquid state when in admixture in the present composition when the composition is at or near room or ambient temperature. The organic liquid material component can have a boiling point that is below the boiling point of water. In certain embodiments where the organic liquid component material includes more than one compound, the average boiling point of the material will be below the boiling point for water. It is also contemplated that in certain embodiments, all compounds present in the liquid material component can be below the boiling point of water.

In certain embodiments, the organic liquid material component can have a boiling point below 100° C. at standard pressure. In certain embodiments, the organic liquid material component can have a boiling point between 50° C. and 100° C.; between 60° C. and 99° C.; between 60° C. and 85° C.; between 60° C. and 80° C.; between 60° C. and 75° C.; between 60° and 70° C. Suitable organic liquid compounds include, but are not limited to polar solvents having a boiling point below 100° C. In certain embodiments, the solvent can be a substituted or unsubstituted C₁ to C₁₀ that includes one or more alcohols, carboxylic acids and the like. Non-limiting examples of suitable compounds include polar protic solvents selected form the group consisting of formic acid, n-butanol, t-butanol, n-propanol, isopropanol, methanol, ethanol, and mixtures thereof.

In the composition as disclosed, the organic liquid material component and water can be present in an water-to-organic ratio between 1:10 and 1:1. In certain embodiments, the water-to-organic ration can be between 2:10 and 1:1; between 3:10 and 1:1; between 4:10 and 1:1; between 5:10 and 1:1. Without being bound to any theory, it is believed that the water-to-organic ratio can be that sufficient to alter at least one characteristic of the resulting solvent matrix. Non-limiting examples of such characteristics include one or more of evaporative rate characteristics, vapor pressure characteristics, flammability characteristics, and the like.

In certain embodiments, the liquid organic material component can be present in the composition in an amount greater than 50 volume percent of the total composition. It is also contemplated that the liquid organic material can be present in an amount between 50 volume percent and 95 volume percent; between 55 volume percent and 95 volume percent; between 60 volume percent and 95 volume percent; between 65 volume percent and 95 volume percent; between 70 volume percent and 95 volume percent; between 75 volume percent and 95 volume percent; between 80 volume percent and 95 volume percent; between 85 volume percent and 95 volume percent; between 90 volume percent and 95 volume percent; between 55 volume percent and 90 volume percent; between 60 volume percent and 90 volume percent; between 65 volume percent and 90 volume percent; between 70 volume percent and 90 volume percent; between 75 volume percent and 95 volume percent; between 80 volume percent and 90 volume percent; between 85 volume percent and 90 volume percent; 55 volume percent and 95 volume percent; between 60 volume percent and 85 volume percent; between 65 volume percent and 85 volume percent; between 70 volume percent and 85 volume percent; between 75 volume percent and 85 volume percent; between 80 volume percent and 85 volume percent; 55 volume percent and 80 volume percent; between 60 volume percent and 80 volume percent; between 65 volume percent and 80 volume percent; between 70 volume percent and 80 volume percent; between 75 volume percent and 80; 55 volume percent and 75 volume percent; between 60 volume percent and 75 volume percent; between 65 volume percent and 75 volume percent; between 70 volume percent and 75 volume percent; 55 volume percent and 70 volume percent; between 60 volume percent and 70 volume percent; between 65 volume percent and 70 volume percent; 55 volume percent and 65 volume percent; between 60 volume percent and 65 volume percent.

The organic liquid material component is present in admixture with the water component in the composition as disclosed herein. In certain embodiments, the water component can be present in an amount below 50 volume percent. In certain embodiments, the water compound can be present in an amount between 1 volume percent and 50 volume percent; between 2 volume percent and 50 volume percent; between 3 volume percent and 50 volume percent; between 4 volume percent and 50 volume percent; between 5 volume percent and 50 volume percent; between 6 volume percent and 50 volume percent; between 7 volume percent and 50 volume percent; between 8 volume percent and 50 volume percent; between 9 volume percent and 50 volume percent; between 10 volume percent and 50 volume percent; between 15 volume percent and 50 volume percent; between 20 volume percent and 50 volume percent; between 25 volume percent and 50 volume percent; between 30 volume percent and 50 volume percent; between 35 volume percent and 50 volume percent; between 40 volume percent and 50 volume percent; between 45 volume percent and 50 volume percent; 1 volume percent and 45 volume percent; between 2 volume percent and 45 volume percent; between 3 volume percent and 45 volume percent; between 4 volume percent and 45volume percent; between 5 volume percent and 45 volume percent; between 6 volume percent and 45 volume percent; between 7 volume percent and 45 volume percent; between 8 volume percent and 45 volume percent; between 9 volume percent and 45 volume percent; between 10 volume percent and 45 volume percent; between 15 volume percent and 45 volume percent; between 20 volume percent and 45 volume percent; between 25 volume percent and 45 volume percent; between 30 volume percent and 45 volume percent; between 35 volume percent and 45 volume percent; between 40 volume percent and 45 volume percent; 1 volume percent and 40 volume percent; between 2 volume percent and 40 volume percent; between 3 volume percent and 40 volume percent; between 4 volume percent and 40 volume percent; between 5 volume percent and 40 volume percent; between 6 volume percent and 40 volume percent; between 7 volume percent and 40 volume percent; between 8 volume percent and 40 volume percent; between 9 volume percent and 40 volume percent; between 10 volume percent and 40 volume percent; between 15 volume percent and 40 volume percent; between 20 volume percent and 40 volume percent; between 25 volume percent and 40 volume percent; between 30 volume percent and 40 volume percent; between 35 volume percent and 40 volume percent; 1 volume percent and 30 volume percent; between 2 volume percent and 30 volume percent; between 3 volume percent and 50 volume percent; between 4 volume percent and 30 volume percent; between 5 volume percent and 30 volume percent; between 6 volume percent and 30 volume percent; between 7 volume percent and 30 volume percent; between 8 volume percent and 30 volume percent; between 9 volume percent and 30 volume percent; between 10 volume percent and 30 volume percent; between 15 volume percent and 30 volume percent; between 20 volume percent and 30 volume percent; between 25 volume percent and 30 volume percent; 1 volume percent and 20 volume percent; between 2 volume percent and 20 volume percent; between 3 volume percent and 20 volume percent; between 4 volume percent and 20 volume percent; between 5 volume percent and 20 volume percent; between 6 volume percent and 20 volume percent; between 7 volume percent and 20 volume percent; between 8 volume percent and 20 volume percent; between 9 volume percent and 20 volume percent; between 10 volume percent and 20 volume percent; between 15 volume percent and 20 volume percent; 1 volume percent and 10 volume percent; between 2 volume percent and 10 volume percent; between 3 volume percent and 10 volume percent; between 4 volume percent and 10 volume percent; between 5 volume percent and 10 volume percent; between 6 volume percent and 10 volume percent; between 7 volume percent and 10 volume percent; between 8 volume percent and 10 volume percent; between 9 volume percent and 10 volume percent.

The water employed in the composition can be of any suitable purity. Where desired or required, the water employed can be subjected to suitable processes to remove impurities removed that would impair performance or decrease composition stability or performance. Non-limiting examples of impurities may need to be removed in whole or in part can include metal ions, metal salts and anionic species. For example, in certain embodiments, it is believed that halogen ions, particularly fluoride ions can adversely impact the stability and shelf life of one or more of the aqueous formulations disclosed herein. Where desired or required, the water employed can be purified. In certain embodiments, the water employed can be distilled or deionized. In certain embodiments, the water can be distilled or deionized to the point at which, when measured conductively, will have a resistance of at least 1.0 megohm per square centimeter with a purity level of 18 megohm per square centimeter in certain embodiments.

In certain embodiments, the liquid organic material component and water can be present as an admixture that has an organic-to-water ratio as defined between 1 to 1 and 3 to 1. In certain embodiments, the liquid organic material component will be present in the total composition an amount between 50% by volume and 90% by volume, with amounts between 50% volume and 70% by volume in certain embodiments of the composition as disclosed herein.

The composition as disclosed herein also includes an effective amount of at least one quaternary ammonium organosilane compound. The at least one quaternary ammonium organosilane compound can be present in the liquid material as disclosed. Where desired or required, the at least one quaternary ammonium organosilane compound can be present as the quaternary ammonium organosilane compound, trisilanol derivatives, polysiloxanol derivatives and mixtures thereof.

The least one quaternary ammonium organosilane compound can be present in an amount sufficient to enhance the antimicrobial activity of the resulting composition. In certain embodiments, the at least one quaternary ammonium organosilane compound can be present in the composition in an amount sufficient to deposit on a surface to which it is applied in a manner that can reduce microbial contamination on the surface to which it is applied.

The at least one quaternary ammonium organosilane can include silanes represented by the general formula:

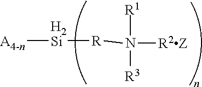

wherein:

A is a moiety selected from —OR⁴, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl, where more than one A is present, each A is independently selected from the groups recited;
R⁴ is selected from hydrogen, substituted or unsubstituted substituted or unsubstituted heteroalkyl, substituted or unsubstituted cycloalkyl, substituted or unsubstituted heterocycloalkyl, substituted or unsubstituted aryl, and substituted or unsubstituted heteroaryl;

R is selected from substituted or unsubstituted alkylene, substituted or unsubstituted heteroalkylene, substituted or unsubstituted cycloalkylene, substituted or unsubstituted heterocycloalkylene, substituted or unsubstituted arylene, and substituted or unsubstituted heteroarylene;

R¹, R², and R³ are independently selected from hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl;

Z is selected from fluoride, chloride, bromide, iodide, tosylate, hydroxide, sulfate and phosphate;

n is an integer 1, 2, or 3.

In one exemplary embodiment, each substituted alkyl, substituted heteroalkyl, substituted cycloalkyl, substituted heterocycloalkyl, substituted aryl, and substituted heteroaryl described herein as possible A, R¹, R², R³, and R⁴ moieties are substituted only with at least one substituent independently selected from —OH, unsubstituted (C₁-C₅)alkyl, unsubstituted 2 to 5 membered heteroalkyl, unsubstituted (C₅-C₇) membered cycloalkyl, unsubstituted 5 to 7 membered heterocycloalkyl, unsubstituted aryl, and unsubstituted heteroaryl. For example, where A is a substituted (C₁-C₁₀)alkyl, the substituted (C₁-C₁₀)alkyl is substituted only with at least one substituent independently selected from —OH, unsubstituted (C₁-C₅)alkyl, unsubstituted 2 to 5 membered heteroalkyl, unsubstituted (C₅-C₇) membered cycloalkyl, unsubstituted 5 to 7 membered heterocycloalkyl, unsubstituted aryl, and unsubstituted heteroaryl.

In related embodiments, each substituted alkyl, substituted heteroalkyl, substituted cycloalkyl, substituted heterocycloalkyl, substituted aryl, and substituted heteroaryl described herein as possible A, R¹, R², R³, and R⁴ moieties are substituted only with at least one substituent independently selected from —OH, unsubstituted (C₁-C₅)alkyl, unsubstituted 2 to 5 membered heteroalkyl, unsubstituted (C₅-C₇) membered cycloalkyl, unsubstituted 5 to 7 membered heterocycloalkyl, unsubstituted aryl, and unsubstituted heteroaryl. In another related embodiment, each substituted alkyl, substituted heteroalkyl, substituted cycloalkyl, substituted heterocycloalkyl, substituted aryl, and substituted heteroaryl described herein as possible A, R¹, R², R³, and R⁴ moieties are substituted only with at least one substituent independently selected from —OH, unsubstituted (C₁-C₅) alkyl, unsubstituted (C₁-C₇) membered cycloalkyl, and unsubstituted phenyl. In yet another related embodiment, each substituted alkyl, substituted heteroalkyl, substituted cycloalkyl, substituted heterocycloalkyl, substituted aryl, and substituted heteroaryl described herein as possible A, R¹, R², R³, and R⁴ moieties are substituted only with at least one unsubstituted (C₁-C₃) alkyl.

In another exemplary embodiment, each substituted alkylene, substituted heteroalkylene, substituted cycloalkylene, substituted heterocycloalkylene, substituted arylene, and substituted heteroarylene described herein as possible R moieties are substituted only with at least one substituent independently selected from —OH, unsubstituted (C₁-C₅)alkyl, unsubstituted 2 to 5 membered heteroalkyl, unsubstituted (C₅-C₇) membered cycloalkyl, substituted 5 to 7 membered heterocycloalkyl, unsubstituted aryl, and unsubstituted heteroaryl.

In another related embodiment, In a related embodiment, each substituted alkylene, substituted heteroalkylene, substituted cycloalkylene, substituted heterocycloalkylene, substituted arylene, and substituted heteroarylene described herein as possible R moieties are substituted only with at least one substituent independently selected from —OH, unsubstituted (C₁-C₅)alkyl, unsubstituted 2 to 5 membered heteroalkyl, unsubstituted (C₅-C₇) membered cycloalkyl, unsubstituted 5 to 7 membered heterocycloalkyl, unsubstituted aryl, and unsubstituted heteroaryl. In another related embodiment, each substituted alkylene, substituted heteroalkylene, substituted cycloalkylene, substituted heterocycloalkylene, substituted arylene, and substituted heteroarylene described herein as possible R moieties are substituted only with at least one substituent independently selected from —OH, unsubstituted (C₁-C₅)alkyl, unsubstituted (C₅-C₇) membered cycloalkyl, and unsubstituted phenyl. In yet another related embodiment, each substituted alkylene, substituted heteroalkylene, substituted cycloalkylene, substituted heterocycloalkylene, substituted arylene, and substituted heteroarylene described herein as possible R moieties are substituted only with at least one unsubstituted (C₁-C₃)alkyl.

A may be selected from —OR⁴, substituted or unsubstituted (C₁-C₁₀)alkyl, substituted or unsubstituted 2 to 12 membered heteroalkyl, substituted or unsubstituted (C₅-C₇)cycloalkyl, substituted or unsubstituted 5 to 7 membered heterocycloalkyl, substituted or unsubstituted aryl, and substituted or unsubstituted heteroaryl. R⁴ may be selected from hydrogen, substituted or unsubstituted (C₁-C₁₀)alkyl, substituted or unsubstituted 2 to 10 membered heteroalkyl, substituted or unsubstituted (C₅-C₇)cycloalkyl, substituted or unsubstituted 5 to 7 membered heterocycloalkyl, substituted or unsubstituted aryl, and substituted or unsubstituted heteroaryl.

In some embodiments, A is selected from —OR⁴, unsubstituted (C₁-C₁₀)alkyl, unsubstituted 2 to 12 membered heteroalkyl, unsubstituted (C₅-C₇)cycloalkyl, unsubstituted 5 to 7 membered heterocycloalkyl, unsubstituted aryl, and unsubstituted heteroaryl. In a related embodiment, A is selected from —OR⁴, unsubstituted (C₁-C₁₀)alkyl, unsubstituted 3 to 12 membered alkylether, unsubstituted (C₅-C₇)cycloalkyl, and unsubstituted phenyl.

A may also be selected from —OR⁴, unsubstituted (C₁-C₄)alkyl, unsubstituted 3 to 8 membered alkylether, unsubstituted (C₅-C₇)cycloalkyl, and unsubstituted phenyl. Alternatively, A is selected from —OR⁴, unsubstituted (C₁-C₄)alkyl, and unsubstituted 3 to 8 membered alkylether,

R⁴ maybe selected from hydrogen, unsubstituted (C₁-C₁₀)alkyl, unsubstituted 2 to 12 membered heteroalkyl, unsubstituted (C₅-C₇)cycloalkyl, unsubstituted 5 to 7 membered heterocycloalkyl, unsubstituted aryl, and unsubstituted heteroaryl.

In some embodiments, R⁴is selected from hydrogen, unsubstituted (C₁-C₁₀)alkyl, unsubstituted 3 to 12 membered alkylether, unsubstituted (C₅-C₇)cycloalkyl, and unsubstituted phenyl. In a related embodiment, R⁴ is selected from hydrogen, unsubstituted (C₁-C₈)alkyl, unsubstituted 3 to 8 membered alkylether, unsubstituted (C₅-C₇)cycloalkyl, and unsubstituted phenyl. Alternatively, R⁴ is selected from hydrogen, unsubstituted (C₁-C₈)alkyl, and unsubstituted 3 to 8 membered alkylether.

R⁴ may also be selected from phenyl, methylphenyl, substituted or unsubstituted (C₁-C₈)alkyl, and —(CH₂)ₓ—O—(CH₂)_{y}CH₃. X and y are integers independently selected from 1 to 10.

R may be selected from substituted or unsubstituted (C₁-C₁₀) alkylene, substituted or unsubstituted 2 to 10 membered heteroalkyene, substituted or unsubstituted (C₅-C₇)cycloalkyene, substituted or unsubstituted 2 to 7 membered heterocycloalkylene, substituted or unsubstituted arylene, and substituted or unsubstituted heteroarylene.

In an exemplary embodiment, R is a member selected from unsubstituted (C₁-C₁₀)alkylene, unsubstituted 2 to 10 membered heteroalkylene, unsubstituted (C₅-C₇)cycloalkylene, unsubstituted 5 to 7 membered heterocycloalkylene, unsubstituted arylene, and unsubstituted heteroarylene. R may also be unsubstituted (C₁-C₁₀) alkylene.

R¹, R², and R³ may be selected from hydrogen, substituted or unsubstituted (C₁-C₂₀)alkyl, substituted or unsubstituted 2 to 20 membered heteroalkyl, substituted or unsubstituted (C₅-C₇)cycloalkyl, substituted or unsubstituted 5 to 7 membered heterocycloalkyl, substituted or unsubstituted aryl, and substituted or unsubstituted heteroaryl.

In some embodiments, R¹, R², and R³ are independently selected from hydrogen, unsubstituted (C₁-C₂₀)alkyl, hydroxy-substituted (C₁-C₂₀)alkyl, amine-substituted (C₁-C₂₀)alkyl, unsubstituted 2 to 20 membered heteroalkyl, unsubstituted (C₅-C₇)cycloalkyl, unsubstituted 5 to 7 membered heterocycloalkyl, unsubstituted aryl, and unsubstituted heteroaryl. In a related embodiment, R¹, R², and R³ are independently selected from hydrogen, unsubstituted (C₁-C₂₀)alkyl, unsubstituted alkylether, hydroxy-substituted (C₁-C₂₀)alkyl, amine-substituted (C₁-C₂₀)alkyl, unsubstituted (C₅-C₇)cycloalkyl, and unsubstituted phenyl.

R¹, R², and R³ may also be selected from hydrogen, unsubstituted (C₁-C₂₀)alkyl, unsubstituted alkylether, hydroxy-substituted (C₁-C₂₀)alkyl, amine-substituted (C₁-C₂₀)alkyl, unsubstituted (C₅-C₇)cycloalkyl, and unsubstituted phenyl. Alternatively, R¹, R², and R³ is selected from hydrogen, unsubstituted (C₁-C₂₀)alkyl, unsubstituted alkylether, hydroxy-substituted (C₁-C₂₀)alkyl, and amine-substituted (C₁-C₂₀)alkyl.

In other exemplary embodiments, R¹, R², and R³ are independently selected from —(CH₂)_{q}OCH₃, —(CH₂)_{q}OH, —(CH₂)_{q}O(CH₂)ₜCH₃, —CH₂)_{q}NHCH₃, —(CH₂)_{q}NH₂, —(CH₂)_{q}N(CH₃)₂ and —(CH₂)_{q}NH₂(CH₂)ₜCH₃, in which q and t are integers independently selected from 0 to 10. R¹, R², and R³ may also members independently selected from the group consisting of —CH₂CH₂OCH₃ and —CH₂CH₂OCH₂CH₂CH₃. Alternatively, R¹, R², and R³ may also be independently selected from —CH₂CH₂OH and —CH₂CH₂CH₂CH(OH)CH₃. R¹, R² and R³ may also be independently selected from —CH₂CH₂NH₂ and —CH₂CH₂N(CH₃)₂. Finally, R¹, R², and R³ may be members independently selected from methyl, octadecyl, didecyl, and tetracecyl.

In certain embodiments, the least one quaternary ammonium organosilane can include silanes represented by the genera formula

A₄₋ₙSi(R NHₐR¹_{b}Z)ₙ

wherein:
A can denote an alkoxy radical with 1 to 8 carbon atoms or an alkylether alkoxy radical with 2 to 10 carbon atoms, or an alkyl radical with 1 to 4 carbon atoms;
R denotes a divalent hydrocarbon radical with 1 to 8 carbon atoms;
R¹ denotes alkyl radicals with 1 to 12 carbon atoms: alkyl ether hydrocarbon radicals of 2 to 12 carbon atoms such as —CH₂CH₂OCH₃ or —CH₂CH₂OCH₂CH₂CH₃; hydroxy containing alkyl radicals of 1 to 10 carbon atoms such as —CH₂CH₂OH or —CH₂CH₂CH₂CH(OH)CH₃ or hydrocarbon radicals of 1 to 10 carbons containing nitrogen such as —CH₂CH₂NH₂ or —CH₂CH₂N(CH₃)₂;
a is 0, 1 or 2, b is 1, 2 or 3, and the sum of a and b is 3;
n is an integer having a value of 1, 2, or 3; and
Z is an anion such as chloride, bromide, iodide, tosylate, hydroxide, sulfate or phosphate.

Non-limiting examples of suitable quaternary ammonium organosilanes include one or more of the following:

(CH₃O)₃Si(CH₂)₃N⁺(CH₃)₂C₁₈H₃₇Cl⁻

(CH₃CH₂O)₃Si(CH₂)₃N⁺(CH₃)₂C₁₈H₃₇Cl⁻

(CH₃O)₃Si(CH₂)₃N⁺(CH₃)₂C₁₈H₃₇Br⁻

(CH₃O)₃Si(CH₂)₃N⁺(C₁₀H₂₁)₂CH₃Cl⁻

(CH₃O)₃Si(CH₂)₃N⁺(CH₃)₂C₁₄H₂₉Cl⁻

(CH₃O)₃Si(CH₂)₃N⁺(CH₃)₂C₁₄H₂₉Br⁻

(CH₃O)₃Si(CH₂)₃N⁺(CH₃)₂C₁₆H₃₃Cl⁻

In certain embodiments, the at least one quaternary ammonium organosilane compound can include one or more of the following: 3-(trimethoxysilyl)propyloctadecyldimethyl ammonium chloride, 3-(trimethoxysilyl)-propyldidecylmethyl ammonium chloride, the trisilanol derivatives and the polysiloxanol derivatives and mixtures thereof. Other quaternary ammonium organosilicon compounds, the silanol derivatives and mixtures thereof, such as 3-(trimethoxysilyl)-propyldimethyltetradecyl ammonium chloride, 3-(trimethoxysilyl)propyldimethylhexadecyl ammonium chloride, 3-(dimethoxymethylsilyl) propyldimethyloctadecyl ammonium chloride and 3-(methoxydimethylsilyl)propyldimethyloctadecyl ammonium chloride may also be employed.

In the composition as disclosed, the at least one quaternary ammonium organosilane compound as disclosed can be present the admixture of water and the organic liquid component such as alcohol such as has been discussed previously. In certain embodiments, the organic component can be an alcohol can be one or more straight chain or branched alcohols having between one and six carbon atoms. In certain embodiments, the alcohol component can be selected from the group consisting of ethanol, propanol, isopropanol butanol, and mixtures thereof.

Non-limiting examples of commercially available quaternary ammonium organosilane compounds can include materials such as are available as 42% active material in methanol under the trademark Dow Corning 5700 (3-(trimethoxysilyl)propyldimethyloctadecyl ammonium chloride) by Aegis Environmental Management, Inc. of Midland, Mich. and Requat 1977 (3-(trimethoxysilyl)-propyldidecylmethyl ammonium chloride) by Sanitized Inc. of New Preston, Conn. Octadecyldimethyl(3-trimethoxysilylpropyl) ammonium chloride (Cat. No. SIO6620.0) as a 60% active solution in methanol, tetradecyldimethyl(3-trimethoxysilylpropyl) ammonium chloride (Cat. No. SIT7090.0) as a 50% solution in methanol and didecylmethyl(3-trimethoxysilylpropyl) ammonium chloride (Cat. No. SID3392.0) as a 42% solution in methanol are offered by Gelest, Inc. of Tullytown, Pa. They are often applied from solvent solutions such as lower alcohols.

Non-limiting examples of quaternary ammonium organosilanes may include 3-(trimethoxysilyl)propyldimethyloctadecyl ammonium chloride and 3-(trimethoxysilyl)propyldidecylmethyl ammonium chloride. Without being bound to any theory, it is believed that, upon addition of these compounds to a liquid containing water, the hydrolysable methoxy groups hydrolyze to form hydroxy substituted silicon atoms termed in the art as silanols with simultaneous liberation of methanol as a by-product of the hydrolysis. The resultant compound formed on addition of quaternary ammonium organosilanes of the above compositions are the respective trisilanol species for 3-(trimethoxysilyl)propyldimethyloctadecyl ammonium chloride (HO)₃Si(CH₂)₃N⁺(CH₃)₂C₁₈H₃₇Cl⁻ and 3-(trimethoxysilyl)didecylmethyl ammonium chloride (HO)₃Si(CH₂)₃N⁺(CH₃) (C₁₀H₂₁)₂Cl⁻.

The composition as disclosed herein can include from 0.01% to 5% by weight of the quaternary ammonium organosilanes described above whether admixed with water singly or jointly as in a mixture of the quaternary ammonium organosilanes. In certain configurations, it is contemplated that the quaternary ammonium organosilane compound can be present in a concentration between 0.1 to 4.0 weight percent. In certain embodiments, the quaternary ammonium organosilane can be present in an amount of 0.2 to 0.3% by weight.

The at least one quaternary ammonium organosilane compound can be present in an amount between 0.1 weight percent and 5 weight percent of the total composition. In certain embodiments the at least one quaternary ammonium organosilane compound can be present in an amount between 0.1. weight percent and 4.5 weight percent of the total composition; between 0.1 weight percent and 4.0 weight percent; 0.1 weight percent and 3.5 weight percent; between 0.1 weight percent and 3.0 weight percent; 0.1 weight percent and 2.5 weight percent; 0.1 weight percent and 2.0 weight percent; 0.1 weight percent and 1.5 weight percent; 0.1 weight percent and 1.2 weight percent; 0.1 weight percent and 1.0 weight percent; between 0.1 weight percent and 0.9 weight percent; 0.1 weight percent and 0.8 weight percent; 0.1 weight percent and 0.7 weight percent; 0.1 weight percent and 0.6 weight percent; between 0.1 weight percent and 0.5 weight percent; between 0.1 weight percent and 0.4 weight percent; between 0.1 weight percent and 0.3 weight percent; between 0.1 weight percent and 0.2 weight percent; 0.2 weight percent and 4.5 weight percent of the total composition; between 0.2 weight percent and 4.0 weight percent; 0.2 weight percent and 3.5 weight percent; between 0.2 weight percent and 3.0 weight percent; 0.2 weight percent and 2.5 weight percent; 0.2 weight percent and 2.0 weight percent; 0.2 weight percent and 1.5 weight percent; 0.2 weight percent and 1.2 weight percent; 0.2 weight percent and 1.0 weight percent; between 0.2 weight percent and 0.9 weight percent; 0.2 weight percent and 0.8 weight percent; 0.2 weight percent and 0.7 weight percent; 0.2 weight percent and 0.6 weight percent; between 0.2 weight percent and 0.5 weight percent; between 0.2 weight percent and 0.4 weight percent; between 0.2 weight percent and 0.3 weight percent; 0.3 weight percent and 4.5 weight percent of the total composition; between 0.3 weight percent and 4.0 weight percent; 0.3 weight percent and 3.5 weight percent; between 0.3 weight percent and 3.0 weight percent; 0.3 weight percent and 2.5 weight percent; 0.3 weight percent and 2.0 weight percent; 0.3 weight percent and 1.5 weight percent; 0.3 weight percent and 1.2 weight percent; 0.3 weight percent and 1.0 weight percent; between 0.3 weight percent and 0.9 weight percent; 0.3 weight percent and 0.8 weight percent; 0.3 weight percent and 0.7 weight percent; 0.3 weight percent and 0.6 weight percent; between 0.3 weight percent, and 0.5 weight percent; 0.4 weight percent and 4.5 weight percent of the total composition; between 0.4 weight percent and 4.0 weight percent; 0.4 weight percent and 3.5 weight percent; between 0.4 weight percent and 3.0 weight percent; 0.4 weight percent and 2.5 weight percent; 0.4 weight percent and 2.0 weight percent; 0.4 weight percent and 1.5 weight percent; 0.4 weight percent and 1.2 weight percent; 0.4 weight percent and 1.0 weight percent; between 0.3 weight percent and 0.9 weight percent; 0.4 weight percent and 0.8 weight percent; 0.4 weight percent and 0.7 weight percent; 0.4 weight percent and 0.6 weight percent; between 0.4 weight percent and 0.5 weight, percent; 0.5 weight percent and 4.5 weight percent of the total composition; between 0.5 weight percent and 4.0 weight percent; 0.5 weight percent and 3.5 weight percent; between 0.5 weight percent and 3.0 weight percent; 0.5 weight percent and 2.5 weight percent; 0.5 weight percent and 2.0 weight percent; 0.5 weight percent and 1.5 weight percent; 0.5 weight percent and 1.2 weight percent; 0.5 weight percent and 1.0 weight percent; between 0.5 weight percent and 0.9 weight percent; 0.5 weight percent and 0.8 weight percent; 0.5 weight percent and 0.7 weight percent; 0.5 weight percent and 0.6 weight percent; 0.7 weight percent and 4.5 weight percent of the total composition; between 0.7 weight percent and 4.0 weight percent; 0.7 weight percent and 3.5 weight percent; between 0.7 weight percent and 3.0 weight, percent; 0.7 weight percent and 2.5 weight percent; 0.7 weight percent and 2.0 weight percent; 0.7 weight percent and 1.5 weight percent; 0.7 weight percent and 1.2 weight percent; 0.7 weight percent and 1.0 weight percent; between 0.7 weight percent and 0.9 weight percent; 0.7 weight percent and 0.8 weight percent; 1.0 weight percent and 4.5 weight percent of the total composition; between 1.0 weight percent and 4.0 weight percent; 1.0 weight percent and 3.5 weight percent; between 1.0 weight percent and 3.0 weight percent; 1.0 weight percent and 2.5 weight percent; 1.0 weight percent and 2.0 weight percent; 1.0 weight percent and 1.5 weight percent; 1.0 weight percent and 1.2 weight percent.

Where desired or required, the composition disclosed herein optionally can also include a quaternary ammonium compound. In certain embodiments, the quaternary ammonium compound selected from the group that includes compounds having the general formula:

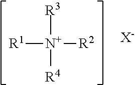

wherein
R¹ is a benzyl group, a C₁-C₂₂ alkyl or an optionally aryl substituted alkyl group;
R² and R³ are independently optionally substituted C₁-C₂₂ alkyl groups;
R⁴ is selected from the group consisting of an optionally substituted alkyl or aryl-substituted alkyl group, benzyl group, and [(CH₂)₂—O]ₙ—R⁵, wherein n is an integer from 1 to 20 and R⁵ is selected from the group consisting of hydrogen, phenyl, and alkyl-substituted phenyl; and
X⁻ is chlorine, bromine, phosphate, sulfate, or nitrate.

In certain embodiments, the at least one quaternary ammonium compound can have R¹ and R⁴ as the same benzyl groups or C₁₋₂₂ alkyl or aryl-substituted alkyl groups; in some aspects, R¹ and R⁴ are independently C₁₋₂₂ alky groups; and in some aspects at least one can be a C₁₀ alkyl such as n-decyl. In some embodiments, R² and R³ can be independently C₁₋₂₂ alkyl and in some embodiments, the same C₁₋₂₂ alkyl.

In certain embodiments, the at least one quaternary ammonium compound can have the general formula:

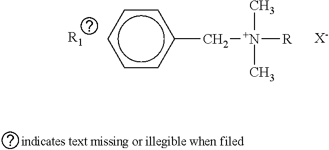

wherein R is a C₈ to C₂₄ alkyl

R₁ is CH₃, C₂H₅, or H

X is Cl⁻ or Br⁻;

and compounds having the general formula:

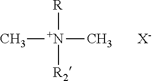

wherein R is a C₈ to C₂₄ alkyl

R₂ is a C₈ thru C₂₄ alkyl

X=Cl⁻ or Br⁻

The at least one quaternary ammonium compound employed in the composition disclosed can be present in an amount between 0 and 5 weight percent with the at least one quaternary ammonium compound being present in amounts between 0 and 4 weight percent; between 0 and 3 weight percent; between 0 and 2 weight percent; between 0 and 1 weight percent; between 0 and 0.5 weight percent; between 0 and 0.3 weight percent; between 0.1 and 5 weight percent; between 0.1 and 4 weight percent; between 0.1 and 3 weight percent; 0.1 and 2 weight percent; between 0.1 and 1 weight percent; between 0.1 and 0.9 weight percent; between 0.1 and 0.8 weight percent; between 0.1 and 0.7 weight percent; between 0.1 and 0.6 weight percent; between 0.1 and 0.5 weight percent; between 0.1 and 0.4 weight percent; between 0.1 and 0.3 weight percent; between 0.1 and 0.2 weight percent; between 0.3 and 5 weight percent; between 0.3 and 4 weight percent; between 0.3 and 3 weight percent; 0.3 and 2 weight percent; between 0.3 and 1 weight percent; between 0.3 and 0.9 weight percent; between 0.3 and 0.8 weight percent; between 0.3 and 0.7 weight percent; between 0.3 and 0.6 weight percent; between 0.3 and 0.5 weight percent; between 0.3 and 0.4 weight percent.

In certain embodiments the at least one quaternary ammonium compound. can include but are not limited to benzalkonium chloride (BAC), benzethonium chloride, other benzalkonium or benzethonium halides, cetylpyridinium chloride, dequalinium chloride, N-myristyl-N methylmorpholinium methyl sulfate, poly[N-[3-(dimethylammonio)propyl]-N′-[3-(ethyleneoxyethelene dimethylammonio)propyl]urea dichloride], alpha-4-[1-tris(2-hydroxyethyl)ammonium chloride-2-butenyl]-omegatris(2-hydroxyethyl)ammonium chloride, alpha4-[1-tris(2hydroxyethyl)ammonium chloride-2-butenyl]poly[1-dimethyl ammonium chloride-2-butenyl]-omega-tris(2hydroxyethyl) ammonium chloride, poly[oxyethylene(dimethyliminio)ethylene(dimethyliminio)-ethylene dichloride], ethyl hexadecyl dimethyl ammonium ethyl sulfate, dimethyl ammonium ethyl sulfate, dimethylethyl-benzyl ammonium chloride, dimethylbenzyl ammonium chloride, cetyldimethylethyl ammonium bromide, monoalkyltrimethyl ammonium salts, dialkyldimethyl ammonium salts, heteroaromatic ammonium salts, polysubstituted quaternary ammonium salts, bis-quaternary ammonium salts, and polymeric quaternary ammonium salts, n-alkyl dialkyl benzyl ammonium chlorides, n-alkyl (C₁₂, C₁₄, C₁₆) dimethyl benzyl ammonium chloride.

In certain embodiments, the at least one quaternary ammonium compound can be benzalkonium chloride having the general formula:

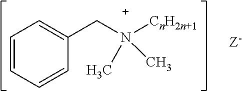

wherein n is an integer 8, 10, 12, 14, 16, 18 and Z is chloride and Z is a halide. Such compounds can be referred to as alkyldimethylbenzylammonium chloride (ADBAC). In certain embodiments, the alkyldimethylbenzylammonium chloride (ADBAC) can be a mixture of alkylbenzyldimethylammonium chlorides in which the alkyl has various even-numbered alkyl chain lengths.

The benzalkonium chloride compound can be present in an amount between 0.01 to 5 weight percent; between 0.01 and 4 weight percent; between 0.01 and 3 weight percent; between 0.01 and 2 weight percent; between 0.01 and 1 weight percent; between 0.01 and 0.8 weight percent; between 0.01 and 0.7 weight percent; between 0.01 and 0.5; between 0.01 and 0.3 weight percent; between 0.01 and 0.2 weight percent between 0.01 and 0.1 weight percent; between 0.01 and 0.05 weight percent. In certain embodiments, the benzalkonium chloride compound can be present in an amount between 0.1 and 4 weight percent.; between 0.1 and 3 weight percent; between 0.1 and 2 weight percent; between 0.1 and 1 weight percent; between 0.1 and 0.8 weight percent; between 0.1 and 0.7 weight percent; between 0.1 and 0.5; between 0.1 and 0.3 weight percent; between 0.2 and 4 weight percent; between 0.2 and 3 weight percent; between 0.2 and 2 weight percent; between 0.2 and 1 weight percent; between 0.2 and 0.8 weight percent; between 0.2 and 0.7 weight percent; between 0.2 and 0.5; between 0.2 and 0.4 weight percent; between 0.2 to 0.3% by weight.

Where desired or required, the composition can also include suitable surfactant compound. In certain embodiments the surfactant compounds can include at least one tert-amine oxide compound from the group that includes compounds having the general formula:

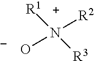

wherein at least one of R¹, R², R³ is independently a substituted or unsubstituted C₈-C₂₀ alkyl group, substituted or unsubstituted C₈-C₂₀ alkenyl group, wherein the alkyl or alkenyl groups may be a straight chain or branched chain primary or secondary group; and at least one of R¹, R², R³ is independently a substituted or unsubstituted C₁-C₅ alkyl group, substituted or unsubstituted C₁-C₅ alkenyl group wherein the alkyl or alkenyl groups may be a straight chain or branched chain primary or secondary group as appropriate.

In certain embodiments, the at least one tert amine can be one in R¹ is a substituted or unsubstituted C₈-C₂₀ alkyl group, substituted or unsubstituted C₈-C₂₀ alkenyl group, wherein the alkyl or alkenyl groups may be a straight chain or branched chain primary or secondary group; and R², R³ are each independently a substituted or unsubstituted C₁-C₅ alkyl group, substituted or unsubstituted C₁-C₅ alkenyl group wherein the alkyl or alkenyl groups may be a straight chain or branched chain primary or secondary group as appropriate.

In certain embodiments, the tert-amine can be an amine oxide compound such as a C₁₀₋₂₀ alkyl or alkenyl dimethyl amine oxides wherein the C₁₀₋₂₀ alkyl or alkenyl groups may be a straight chain or branched chain primary or secondary group such as lauryl, cocoyl, cetyl, tallow, oleyl, linoleyl or octadecyl.

In certain embodiments, the tert-amine can be an alkyl amine oxide selected from the group consisting of alkyldimethylamine oxide, alkylamine oxide and mixtures thereof wherein the alkyl group has between eight and eighteen carbon atoms. Without being bound to any theory, it is believed that the compound can be an amine oxide surfactant such as a lauryl dimethylamine oxide which can solubilize proteins and effective against certain bacteria such as S. aureus and/or E. coli. It is also within the purview of this disclosure to employ myristamine oxide where desired or required. Such materials can alternately be called lauramine oxide (also alternatively known as lauryldimethylamine oxide, dodecyldimethylamine oxide, or dimethyldodecylamine-N-oxide). Non-limiting examples of suitable commercially available materials include material under the tradename Mackamine LO from Rhodia as well as Macat AO-12 (from Mason Chemicals) and Ammonyx LO (from Stepan Chemical).

It is believed that the tert-amine oxide can contribute to the wetting agency of the associated composition and can, in certain applications contribute detergency and soil lifting when applied to a target surface. It is also believed that the tert-amine oxide interacts with one or more composition compounds having available hydroxyl groups to alter the surface tension of the composition relative to the wetting characteristics of the alcohol constituents of the composition and lowers the surface tension of the total composition and enhances wettability of the surface to which the composition is applied.

Where desired or required, the tert-amine oxide such as alkyl amine oxide can be present in the composition as disclosed in an amount sufficient to enhance deposition of components such as the at least one quaternary ammonium silane compound onto the target surface. In certain embodiments, the tert-amine oxide can be present in an amount between 0 and 1.5 weight %. In certain embodiments, the tert-amine oxide compound will be present in an amount sufficient to: 1) lowers the surface tension of the associated composition and/or 2) promotes surface adhesion and even contact between the composition in and the target surface to which it is applied. In certain embodiments, the alkyl amine oxide can be present in an amount between 0 and 1.5 weight %; between 0 and 1.25 weight %; between 0 and 1.0 weight %; between 0 and 0.9 weight %; between o and 0.8 weight %; between 0 and 0.7 weight %; between 0 and 0.6 weight % ; between 0 and 0.5 weight %; between 0 and 0.4 weight %; between 0 and 0.3 weight %; between 0 and 0.2 weight %; between 0 and 0.1 weight %; 0.1 and 0.4 weight %; between 0.1 and 0.3 weight %; between 0.1 and 0.2 weight %; between 0.2 and 0.3 weight %; between 0.2 and 0.4 weight %; between 0.2 and 0.5 weight %; between 0.3 and 0.4 weight %; between 0.3 and 0.5 weight %.

The composition as disclosed may also include a low molecular weight C₃-C₆ polyol compound having two or more hydroxyl groups. In certain embodiments, the low molecular weight C₃-C₆ polyol can have three or more hydroxyl groups. The C₃-C₆ group can have one or more regions of unsaturation as desired or required. The C₃-C₆ group can be substituted or substituted and can include one or more heteroaryl moiety such as oxygen, nitrogen or the like as desired or required. In certain embodiments, the low molecular weight polyol can be one or more compounds such as glycerol, triethylene glycol, propylene glycol, sorbitol, mannitol, erythritol, and the like. When present, it is theorized that the low molecular weight C₃-C₆ polyol compound, when present, can interface with the tert-amine oxide in a manner that assists in carrying the at least one quaternary ammonium silane compound in a manner that enhances the interaction between the target surface and the total composition as disclosed.

When present, the low molecular weight C₃-C₆ polyol compound can be present in an amount that enhances interaction between the target surface and the composition as disclosed. In certain embodiments, the low molecular weight C₃-C₆ polyol compound can be present in an amount between 0 and 2.0 weight %; between 0 and 1.5 weight %; between 0 and 1.0 weight %; between 0 and 0.9 weight %; between 0 and 0.8 weight %; between 0 and 0.7 weight %; between 0.25 and 0.6 weight %; between 0 and 0.5 weight %; between 0 and 0.4 weight %; between 0 and 0.3 weight %; between 0 and 0.2 weight % between 0 and 0.1 weight %; between 0.25 and 2.0 weight %; between 0.25 and 1.5 weight %; between 0.25 and 1.0 weight %; between 0.25 and 0.9 weight %; between 0.25 and 0.8 weight %; between 0.25 and 0.7 weight %; between 0.25 and 0.6 weight %; between 0.25and 0.5 weight %; between 0.25 and 0.4 weight %; between 0.25 and 0.3 weight %.

Where desired or required, the composition as disclosed can also include amounts of one or more of hydrogen peroxide ad/or hypochlorite compounds and/or chlorhexidene compounds, in an amount between 0 and 3 weight %, respectively. In certain embodiments, the each of the enumerated compounds can be present in an amount between 0 and 0.1 weight %; between 0 and 0.2 weight %; between 0 and 0.3 weight %; between 0 and 0.4 weight %; between 0 and 0.5 weight %; between 0.1 and 0.2 weight %; between 0.1 and 0.3 weight %; between 0.1 and 0.4 weight %; between 0.1 and 0.5 weight %; between 0.1 and 1 weight %; between 0.1 and 1.5 weight %; between 0.1 and 2 weight %; between 0.1 and 2.5 weight %; between 0.1 and 3.0 weight %; between 0.2 and 0.3 weight %; between 0.2 and 0.4 weight %; between 0.2 and 0.5 weight %; between 0.2 and 0.3 weight %; between 0.2 and 0.4 weight %; between 0.2 and 0.5 weight %; between 0.2 and 1 weight %; between 0.2 and 1.5 weight %; between 0.2 and 2 weight %; between 0.2 and 2.5 weight %; between 0.2 and 3.0 weight %; between 0.3 and 0.4 weight %; between 0.3 and 0.5 weight %; between 0.3 and 1 weight %; between 0.3 and 1.5 weight %; between 0.3 and 2 weight %; between 0.3 and 2.5 weight %; between 0.3 and 3.0 weight %; between 0.5 and 1 weight %; between 0.5 and 1.5 weight %; between 0.5 and 2 weight %; between 0.5 and 2.5 weight %; between 0.5 and 3.0 weight %; between 1 and 1.5 weight %; between 1 and 2 weight %; between 1 and 2.5 weight %; between 1 and 3.0 weight %; between 2 and 2.5 weight %; between 2 and 3.0 weight %.

Non-limiting examples of hypochlorite compounds suitable hypochlorite compounds include sodium hypochlorite, calcium hypochlorite and the like. Non-limiting examples of chlorhexidine compounds include chlorhexidine free base, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine diiodobutyrate, chlorhexidine di-n-valerate, chlorhexidine dicaproate, chlorhexidine malonate, chlorhexidine succinate, chlorhexidine malate, chlorhexidine tartrate, chlorhexidine dimonoglycolate, chlorhexidine monodiglycolate, chlorhexidine dilactate, chlorhexidine chlorhexidine di-isothionate, chlorhexidine dibenzoate, chlorhexidine dicinnamate, chlorhexidine dimandelate, chlorhexidine di-isophthalate, chlorhexidine di-2hydroxynaphthoate, and chlorhexidine embonate.

The composition has disclosed herein may further include an additive selected from the group consisting of colorants, fragrance enhancers, nonionic surfactants, corrosion inhibiting agents, defoamers, pH stabilizers and stabilizing agents as desired or required.

It is contemplated that the composition can be present as an admixed solution of the respective components and can be applied by and suitable manner to the surface to be treated. Non-limiting examples of application methods include spraying, wiping, fogging, and the like.

In certain embodiments, the composition as disclosed can be applied in a manner that wets the target surface to which it is applied. It is believed that, upon application of the composition, microbiological pathogens are initially activated by contact with the alcoholic component of the composition. It is believed that, when present, the alkyl amine oxide component to reduce or lift soil and non-microbiological pathogen contamination exposing additional surface areas in the process.

The composition is effective against various microscopic and sub-microscopic pathogens. These can include various bacteria, viruses and fungi. Non-limiting examples include various gram-positive bacteria such as geti Citrobacter freundii, Citrobacter diversus, Corynebacterium diptheriae, Diplococcus pneumoniae, Micrococcus sp. (I), Micrococcus sp. (II), Micrococcus sp. (III), Mycobacterium spp., Staphylococcus albus, Staphylococcus aureus, Staphylococcus citrens, Staphylococcus epidermidis, Streptococcus faecalis, Streptococcus pyogenes. Non-limiting examples include gram negative bacteria such as Acinetobacter calcoaceticus, Enterobacter aerogenes, Enterobacter aglomerans (I), Enterobacter aglomerans (II), Escherichia coli, Klebsiello pneumoniae, Nisseria gonorrhoeae, Proteus mirabilis, Proteus morganii, Proteus vulgaris, Providencia spp., Pseudomonas, Pseudomonas aeruginosa, Pseudomonas fragi, Salmonella choleraesuis, Salmonella enteritidis, Salmonella gallinarum, Salmonella gallinarum, Salmonella schottmuelleri, Salmonella typhimurium, Salmonella typhosa, Serratia marcescens, Shigella flexnerie Type II, Shigella sonnei, Virbrio cholerae.

The composition as disclosed herein is also effective in eliminating and preventing the re-inoculation of viruses to the target surface(s). Non-limiting examples of viruses that can be reduced or eliminated by contact with the composition as disclosed herein include SARS-CoV-2, as well as Adenovirus Type IV, Feline Pneumonitis, Herpes Simplex Type I & II, HIV-I (AIDS), Influenza A virus, Influenza B virus, Poliovirus, Reovirus. The composition is also effective against molds and fungi, non-limiting examples of which are the following: Altemaria altemata, Asperigillus niger, Aureobasidium pullulans, Candida albicans, Cladosporium cladosporioides, Drechslera australiensis, Gliomastix cerealis, Microsporum audouinii, Monilia grisea, Phoma fimeti, Pithomyces chartarum, Scolecobasidium humicola, Trychophyton interdigitale, Trychophyton mentagrophytes.

Also disclosed is a method for cleaning and sanitizing a target surface that includes the steps of applying the composition as disclosed herein to a contact surface. Application of the composition as disclosed can be accomplished in a manner that achieves wetting of the exterior facing surface of the target surface and may optionally include penetration of the composition or components thereof into the subsurface region immediately contiguous with the exterior face surface. Application can include pouring a measure amount on the surface without surface agitation imparted by wiping or the like. Application can also include methods such as spray application, misting fogging and the like. It is contemplated that the composition is applied in a manner that introduces the material and permits at least a portion of the alcoholic component to evaporate or flash off after contact. Without being bound to any theory, it is believed that the alcoholic content itself exhibits a specified antimicrobial activity. One explanation for antimicrobial activity of the alcohol component is denaturation of proteins. It is believed that this antimicrobial activity is enhanced when the alcohol component is admixed with water in the manner as disclosed herein.

Suitable methods of determining an increase in biocidal efficacy are known in the art, Biocidal efficacy can be measured as an increase in percentage kill for a biocidal target after a specified time in contact with the composition (e.g. efficacy percentage). The EPA has regulations regarding required contact times for different surfaces and also accepted regulatory protocols for testing, which are known to one skilled in the art. In another embodiment, the increased biocidal efficacy can be measured as a decrease in the kill time of a composition, e.g, the amount of time necessary to kill at least 99.9% of the biocidal target on a surface after a specified contact time. For example, The EPA-approved and industrial standard contact time for a bucket-dilutable composition using a use dilution test for major biocidal targets, e.g. Staphylococcus aureus, Salmonella enterica, and Pseudomonas aeruginosa, etc., is 10 minutes.

There exists a need for shorter contact times of disinfectant compositions with, for example, a work surface to approximate real world use of these compositions. Thus, determined by OECD Quantitative Method for Evaluating Bacterial Activity of Microbiocides Used on Hard Non-Porous Surfaces, the compositions of the invention can have a microbial contact kill time of less than about 10 minutes. In certain embodiments the microbial contact kill time can be less than about 5 minutes. In certain embodiments, the compositions as disclosed herein can have a microbial contact kill time of about 3 minutes or less, alternatively about 2 minutes or less, alternatively about 1 minute or less, alternatively about 30 seconds or less.

In order to further illustrate the present disclosure, the following examples of presented. The Examples are for illustration purposes and are not to be considered limitative of the present disclosure.

### EXAMPLE I

Test compositions A, B, C, D and E are prepared by the admixture of the components listed in the amounts enumerated in Table A. The compositions are optically clear water white compositions that exhibit little to no separation or opacity. Samples of each test composition are evaluated for shelf stability at ambient temperature (23° C.); low temperature (0° C.); and high temperature (32°). Each sample is observed and evaluated after two weeks, four weeks and six months and determined to be shelf stable.

TABLE A
Composition

| Compound | CAS No. | A | B | C | D | E |
|---|---|---|---|---|---|---|
| Ethyl Alcohol | 64-17-5 | 70 vol % | 70 vol % | 70 vol % | 70 vol % | 70 vol % |
| Water | | 30 vol % | 30 vol % | 30 vol % | 30 vol % | 30 vol % |
| Quaternary | 27668-52-6 | 1.5 wt. % | 0.3 wt.% | 0.3 wt % | 0.3 wt % | 0 |
| ammonium | | | | | | |
| silane | | | | | | |
| compound | | | | | | |
| Benzalkonium | 63449-41-2 | 0.5 wt. % | 0.3 wt. % | 0.3 wt % | 0.3 wt % | 0.3 wt % |
| chloride | | | | | | |
| compound | | | | | | |
| Alkyl amine | 1643-20-5 | 0.5% by | 0.5 wt. % | 0.5 wt % | 0.5 wt % | 0.5 wt % |
| oxide | | weight | | | | |
| Low | 56-81-5 | 0 | 0 | 0.3 wt % | 0.3 wt % | 0.3 wt % |
| molecular | | | | | | |
| weight C₃ −C₆ | | | | | | |
| polyol | | | | | | |
| Hydrogen | 7722-84-1 | 0 | 0 | 0 | 0.1 wt % | 0. |
| Peroxide | | | | | | |
| Hypochlorite | 10022-70-5 | 0 | 0 | 0 | 0.1 wt. % | 0 |
| compound | | | | | | |

### EXAMPLE II

Compositions A, B, C, D and E are evaluated for activity against various bacterial pathogens in exposure periods ranging from 10 seconds to 1 hour. Solid test surfaces (stainless steel, polyvinyl chloride, polycarbonate) are inoculated with bacterial pathogen loads under study according to standard test methodology. The test surfaces are evaluated for pathogen population quantity. The prepared test surfaces are wetted with the aliquots of Compositions A, B, C, D and E and permitted to air dry. The test surfaces are evaluated at 10 second, 1 minute, 10 minute and 30 minute intervals. It is found that Pseudomonas aeruginosa, Serratia marcescens, E. coli and Salmonella typhosa, Staphylococcus aureus and Streptococcus pyogenes can be killed in 10 seconds by all compositions. M. tuberculosis can achieve complete destruction in 5 minutes or less based on the mucin-loop test method. Pathogens such as Cryptococcus neoformans, Blastomyces dermatitidis, Coccidioides immitis, and Histoplasma capsulatum in aerosolized culture phases can be completely destroyed in less than one minute.

### EXAMPLE III

Compositions A, B, C, D and E are evaluated for activity against various viral pathogens in exposure periods ranging from 10 seconds to 1 hour. Solid test surfaces (stainless steel, polyvinyl chloride, polycarbonate) are inoculated with viral pathogen loads under study according to standard test methodology. The test surfaces are evaluated for pathogen population quantity. The prepared test surfaces are wetted with the aliquots of Compositions A, B, C, D, and E and permitted to air dry. The test surfaces are evaluated at 10 second, 1 minute, 10 minute and 30 minute intervals. It is found that lipophilic viruses such as herpes, vaccinia, and influenza virus and various hydrophilic viruses such as adenovirus, enterovirus, rhinovirus, and rotaviruses can be killed in under 5 minutes.

### EXAMPLE IV

Compositions A, B, C, D and E are evaluated for activity against various sporicidal pathogens in the manner outlined in Example II and found to have accelerated mycobacterial and fungicidal activity in five minutes with a complete kills of 10⁶ spores of the Bacillus species in 120 minutes or less in composition D.

### EXAMPLE V

Compositions A, B, C, D and E are evaluated for activity against SARS-CoV-2 virus in the manner outlined in Example II and found to have accelerated antiviral activity against the pathogen, with a 10³ log reduction on all test surfaces after one minute and a 10⁶ log reduction after 10 minutes.

### EXAMPLE VI

The test surfaces treated in Examples II, III, IV and V are evaluated against recontamination by either aerosolized contact with a target pathogen or physical contact with a contaminated loop. The samples are permitted to remain uncontacted for given intervals after which they are contaminated with as specific pathogen. Post-treatment recontamination occurs at one-minute post treatment, 10 minutes post treatment, 60 minutes post-treatment, 5 hours post-treatment and 12 hours post treatment, 24 hours post treatment and 72 hours post treatment.

No recontamination is detected in treated samples taken at 1 and 10 minutes post-treatment recontamination intervals. In samples treated with Composition A, B C and D no decontamination is detected at up to 72 hours post treatment recontamination intervals.

### EXAMPLE V

In order to further evaluate and demonstrate the effectiveness against microbial pathogens, three compositions were prepared according to the present disclosure for testing and evaluation. The compositions are outlined in Table B.

TABLE B
TEST COMPOSITION

| Compound | CAS No. | F | G | H |
|---|---|---|---|---|
| Ethyl Alcohol | 64-17-5 | 70 vol % | 70 vol % | 70 vol % |
| Water | | 30 vol % | 30 vol % | 30 vol % |
| Quaternary | 27668-52-6 | 1.5 wt. % | 0.3 wt. % | 0.3 wt % |
| ammonium | | | | |
| silane | | | | |
| compound | | | | |
| Benzalkonium | 63449-41-2 | 0.5 wt. % | 0.3 wt. % | 0.3 wt % |
| chloride | | | | |
| compound | | | | |
| Alkyl amine | 1643-20-5 | 0.5% | 0.5 wt. % | 0.5 wt % |
| oxide | | by weight | | |
| pH | | 7.2 | 7.18 | 7.22 |
| Specific | | 0.912 | 0.911 | 0.913 |
| gravity | | | | |

Each sample appears as clear liquid and are stored at ambient room temperature. The materials are analyzed for pH and specific gravity. The results are collected on Table B.

The samples were evaluated for effectiveness against Staphylococcus aureus and Pseudomonas aeruginosa using the following test methods: AOAC Official Method 955.15 Testing Disinfectants against Staphylococcus aureus Use-Dilution Method; and AOAC Official Method 964.02 Testing Disinfectants against Pseudomonas aeruginosa Use-Dilution Method, respectively using Pseudomonas aeruginosa (bacteria), ATCC #15442 and Staphylococcus aureus (bacteria), ATCC #6538 received from American Type Culture Collection, Manassas, Va.

Test substrates were prepared in the following manner. The biologically screened stainless steel penicylinders (8±I mm o.d.×6±I mm i.d.×10±1 mm length) were soaked. overnight (approximately I2 hours) in IN NaOH. The penicylinders were then rinsed several times with tap water and sterilized at 121° C. and 15 psi in deionized water. The carriers were soaked for 15±2 minutes in the 48 hours culture broth containing 5% FBS in the solution organic load. The carriers were then dried at 36±1° C. for 40±2 minutes in a petri dish with sterile filler paper. The product at its use-dilution was distributed into 25×I50 mm glass disposable test tubes in 10 mL quantities. The samples were brought to 20±1.0° C. in a water bath at the same temperature. The contaminated and dried carriers were transferred with a wire hook into the disinfectant for 10-minute exposure at 30 second staggered intervals.

After I0-minutes contact time the carriers were transferred into the recovery broth; (10 mL in a 20×150 mm test tube for subculture recovery; from medicated carrier). The recovery medium tubes (with carriers) were incubated for 48±2 hours at 36±1° C. in an incubator. Results were recorded as “+” for growth and “O” for no growth. Any positive recovery broth tubes containing carriers were subcultured to appropriate selective/differential agar to confirm the presence of the test system.

To verify that between 1.0×10⁶ to 1.0×10⁷ cfu were present on each carrier; six additional contaminated and dried carriers were placed into recovery broth tubes and sonicated for 1-minute to dislodge the adhering organisms. This was diluted to 10−⁵, and then two 1.0 mL aliquots from each dilution tube were plated using Tryptic Soy Agar (TSA) and incubated up to 48±2 hours at 36±1° C. The colony counts were extrapolated to cfu per carrier. The log 10 density (LD) for each carrier was calculated by taking the log 10 of the density (per carrier). The mean LD across carriers is the mean Test LD for the test. The mean Test LD must be at least 6.0 (1.0×10⁶) and not above 7.0 (1.0×10⁷).

Three contaminated and dried carriers were directly transferred into recovery broth (no disinfection treatment) and incubated for 48±2 hours at 36±1° C. Positive growth in each tube validates test system viability.

Sterility controls were observed in the following manner. Agar Control—Two sterile Petri dishes were poured with sterile TSA from each lot of media used in the test. Recovery Broth Control—Two unopened recovery broth test tubes from the same lots used in the test. Bovine Serum Control—Two 1 mL aliquots of bovine serum were plated with TSA to verify sterility of the serum. Recovery Broth with Carriers Control—To verify the sterility of the carriers, as above, except that one stainless steel penicylinder was added to recovery broth test tube at the start of the test samples (prior to first tube) and second after all test carriers (last tube) have been transferred to recovery broth. All controls were incubated along with the test sample test tubes. These controls verified that the media was sterile and aseptic technique during carrier transfer process was used.

The test results are collected in Tables C, D and E with Sterility Control, Viability Control and Carrier Count Control Results (Tables D and E): Carrier count control and viability control requirements were met. Sterility Control requirements were met. The neutralization confirmation requirements were met. The growth was confirmed to be the test organisms.

Study Results (Table C): Lot #A01004B produced 0 positive of 60 for Staphylococcus aureus and 1 positive of 60 for Pseudomonas aeruginosa, respectively after ten minutes contact time and exposure at 20+1° C., Lot #AO 1005C produced 0 positive of 60 for Staphylococcus aureus and 1 positive of 60 for Pseudomonas aeruginosa, respectively after ten minutes contact time and exposure at 20+1° C. Lot #AO 1006D produced 1 positive of 60 for Staphylococcus aureus and 0 positive of 60 for Pseudomonas aeruginosa, respectively after ten minutes contact time and exposure at 20+1° C. this data indicates that the test material passed.

TABLE C
TEST RESULTS

| Test Organism | Sample number | # Positive tests/#Tested |
|---|---|---|
| Staphylococcus aureus | F | 1/60 |
| | G | 1/60 |
| | H | 1/60 |
| Pseudomonas aeruginosa | F | 1/60 |
| | G | 1/60 |
| | H | 1/60 |

TABLE D
STERILITY CHECK RESULTS

| MEDIA | LOT NUMBER | RESULTS |
|---|---|---|
| Tryptic Soy Agar | A-407 | 0.0 |
| (TSA) | | |
| Recovery Broth | A-281, A-282 | 0.0 0.0 |
| Bovine Serum | 20D171 | 0.0 |
| Carriers [stainless | L-18 | 0.0 |
| steel penicylinders] | | |

TABLE E
CARRIER COUNT RESULTS

| | | | | Total | |
|---|---|---|---|---|---|
| | | Results | Results | average | |
| Test | | (cfu/carrier | (Log 10/ | (Log 10/ | Qualitative |
| Organism | Performance | ×10⁶) | carrier) | carrier) | Control |
| Staphylococcus | (prior | 5.9 | 6.77 | 6.78 | +, +, + |
| aureus | efficacy) | 5.9 | 6.77 | | |
| | | 6.5 | 6.81 | | |
| | (following | 3.1 | 6.49 | 6.55 | |
| | efficacy) | 3.7 | 6.57 | | |
| | | 4.0 | 6.60 | | |
| Staphylococcus | (prior | 1.6 | 6.20 | 6.20 | +, +, + |
| aureus | efficacy) | 1.5 | 6.18 | | |
| | | 1.7 | 6.23 | | |
| | (following | 5.4 | 6.73 | 6.72 | |
| | efficacy) | 5.2 | 6.71 | | |
| | | 5.2 | 6.72 | | |
| Staphylococcus | (prior | 5.4 | 6.73 | 6.8 | +, +, + |
| aureus | efficacy) | 7.2 | 6.86 | | |
| | | 6.6 | 6.82 | | |
| | (following | 3.8 | 6.59 | 6.58 | |
| | efficacy) | 4.1 | 6.73 | | |
| | | 3.5 | 6.82 | | |
| Pseudomonas | (prior | 3.9 | 6.59 | 6.72 | +, +, + |
| aeruginosa | efficacy) | 5.4 | 6.73 | | |
| | | 6.7 | 6.82 | | |
| | | 3.2 | 6.51 | 6.54 | |
| | | 3.4 | 6.53 | | |
| | | 3.9 | 6.59 | | |
| Pseudomonas | (prior | 4.6 | 6.66 | 6.73 | +, +, + |
| aeruginosa | efficacy) | 5.2 | 6.72 | | |
| | | 6.6 | 6.82 | | |
| | (following | 3.5 | 6.54 | 6.52 | |
| | efficacy) | 3.2 | 6.50 | | |
| | | 3.4 | 6.53 | | |
| Pseudomonas | (prior | 1.3 | 6.11 | 6.11 | +, +, + |
| aeruginosa | efficacy) | 1.3 | 6.11 | | |
| | | 1.3 | 6.11 | | |
| | (following | 1.1 | 6.04 | 6.04 | |
| | efficacy) | 1.1 | 6.05 | | |
| | | 1.1 | 6.04 | | |

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A composition comprising:
an effective amount of at least one quaternary ammonium silane compound;
an effective amount of at least one benzalkonium chloride compound;
between 10 percent and 50 percent water; and
between 50 volume percent and 90 volume percent of organic liquid material that has a boiling point less than water,
wherein the composition is effective against one or more microbiological pathogens.

2. The composition of claim 1 wherein the organic liquid material includes a short-chain alcohol having between one and six carbon atoms.

3. The composition of claim 1 further comprising an alkyl amine oxide selected from the group consisting of alkyldimethylamine oxide, alkylamine oxide and mixtures thereof wherein the alkyl group has between eight and eighteen carbon atoms.

4. The composition of claim 2 wherein the alkyl amine oxide is selected form the group consisting of myristamine oxide, lauryldimethylamine oxide and mixtures thereof.

5. The composition of claim 2 wherein the alkyl amine oxide is present in an amount between 0.1 and 1 weight percent.

6. The composition of claim 5 wherein the alkyl amine oxide is present in an amount between 0.1 weight percent and 0.5 weight percent.

7. The composition of claim 1 wherein the quaternary ammonium silane compound is selected from the group consisting of tetradecyl ammonium silane, 3-(trimethoxysilyl)propyl octadecyldimethyl ammonium chloride, 3-(trimethoxysilyl)-propyl didecylmethyl ammonium chloride, the trisilanol derivatives and the polysiloxanol derivatives and mixtures thereof, 3-(trimethoxysilyl)-propyl dimethyltetradecyl ammonium chloride, 3-(tximethoxysilyl)propyl dimethyl-hexadecyl ammonium chloride, 3-(dimethoxymethylsilyl) propyl dimethyloctadecyl ammonium chloride and 3-(methoxydimethylsilyl)propyl dimethyloctadecyl ammonium chloride and mixtures thereof.

8. The composition of claim 1 wherein the quaternary ammonium organosilane compound is present in an amount between 0.1 volume percent and 1.5 volume percent.

9. The composition of claim 8 wherein the quaternary ammonium organosilane compound is present in an amount between 0.2 volume percent and 0.5 volume percent.

10. The composition of claim 1 wherein the benzalkonium chloride compound is N-alkyl-N-benzyl-N,N-dimethylammonium chloride wherein the alkyl group has between 6 and 20 carbon atoms.

11. The composition of claim 1 further comprising an alkyl amine oxide selected from the group consisting of alkyldimethylamine oxide, alkylamine oxide and mixtures thereof wherein the alkyl group has between eight and eighteen carbon atoms, wherein the alkyl amine oxide is present in an amount between 0 and 1 weight percent,
wherein the quaternary ammonium silane compound is present in an amount between 0.1 volume percent and 1.5 volume percent and is selected from the group consisting of tetradecyl ammonium silane, 3-(trimethoxysilyl)propyl octadecyldimethyl ammonium chloride, 3-(trimethoxysilyl)-propyl didecylmethyl ammonium chloride, the trisilanol derivatives and the polysiloxanol derivatives and mixtures thereof, 3-(trimethoxysilyl)-propyl dimethyltetradecyl ammonium chloride, 3-(trimethoxysilyl)propyl dimethyl-hexadecyl ammonium chloride, 3-(dimethoxymethylsilyl) propyl dimethyloctadecyl ammonium chloride and 3-(methoxydimethylsilyl)propyl dimethyloctadecyl ammonium chloride and mixtures thereof.

12. A composition comprising:
at least one quaternary ammonium silane compound, the at least one quaternary ammonium silane compound present in an amount between 0.1 volume percent and 1.5 volume percent;
at least one benzalkonium chloride compound, the at least one benzalkonium chloride compound, present in an amount between 0.1 and 1 weight percent;
between 10 volume percent and 50 volume percent water; and
between 50 volume percent and 90 volume percent of organic liquid material that has a boiling point less than water, the organic liquid material comprising at least one short-chain alcohol having between one and six carbon atoms;
an alkyl amine oxide present in an amount between 0.1 and 1 weight percent, the alkyl amine oxide selected from the group consisting of alkyldimethylamine oxide, alkylamine oxide and mixtures thereof wherein the alkyl group has between eight and eighteen carbon atoms;
wherein the composition is effective against one or more microbiological pathogens.

13. The composition of claim 12 wherein the alkyl amine oxide is present in an amount between 0.1 weight percent and 0.5 weight percent.

14. The composition of claim 12 wherein the quaternary ammonium silane compound is selected from the group consisting of tetradecyl ammonium silane, 3-(trimethoxysilyl)propyl octadecyldimethyl ammonium chloride, 3-(trimethoxysilyl)-propyl didecylmethyl ammonium chloride, the trisilanol derivatives and the polysiloxanol derivatives and mixtures thereof, 3-(trimethoxysilyl)-propyl dimethyltetradecyl ammonium chloride, 3-(trimethoxysilyl)propyl dimethyl-hexadecyl ammonium chloride, 3-(dimethoxymethylsilyl) propyl dimethyloctadecyl ammonium chloride and 3-(methoxydimethylsilyl)propyl dimethyloctadecyl ammonium chloride and mixtures thereof and is present in an mount between 0.2 volume percent and 0.5 volume percent.

15. The composition of claim 12 wherein the benzalkonium chloride compound is N-alkyl-N-benzyl-N,N-dimethylammonium chloride wherein the alkyl group has between 6 and 20 carbon atoms.

16. A method of treating a surface, the surface having at least one microbiological pathogen, wherein the method comprises the step of:
applying a topical composition to the surface to be treated, the topical composition comprising:
an effective amount of at least one quaternary ammonium silane compound;
an effective amount of at least one benzalkonium chloride compound;
between 10 percent and 50 percent water; and
between 50 volume percent and 90 volume percent of organic material that has a boiling point less than water and wherein the organic material includes a short-chain alcohol having between one and six carbon atoms; and
allowing the topical composition to contact at least one microbiological pathogen for an interval sufficient to inactivate the at least one microbiological pathogen.

17. The method of claim 12 wherein the applied material produces a coating that is active against the at least one microbiological pathogen for an interval of at least 12 hours.

18. The method of claim 13 wherein the applied coating is active against the at least one microbiological pathogen for an interval of at least 24 hours.

19. The method of claim 12 wherein the applied coating is active against reinoculation of the at least one microbiological pathogen for an interval of at least 12 hours.

20. The method of claim 12 wherein the coating is applied by at least one of the following: spraying, aerosol spraying, wiping.
